(19) United States
(12) Patent Application Publication
(10) Pub. No.: US 2004/0046793 A1
(43) Pub. Date: Mar. 11, 2004

(54) Program generation method

(76) Inventors: Takumi Tanaka, Yokohama (JP); Kenichi Morisaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/606,955

(22) Filed: Jun. 27, 2003

(30) Foreign Application Priority Data
Jun. 28, 2002 (JP) 2002-188938

(51) Int. Cl. G09G 5/00; G06F 9/00

(52) U.S. Cl. 345/763; 719/328

(57) ABSTRACT

Using information from a screen file, an application program skeleton is generated to cooperate with a program coded in a language such as COBOL. By defining input data for a form necessary for the screen file and by defining a function name of an application program and a language used to develop the program, a unit which conceals type conversion and parameter setting from a developer is generated and a skeleton of an application program which is called from the unit is generated.

### BACKGROUND OF THE INVENTION

The present invention relates to a program generation technique to generate a program associated with a screen using screen input information via a browser and a program execution technique to execute the program generated by the program generation technique.

In system development in which input information obtained from a file described in a screen display language is processed on a server side, it is common to transmit input parameters at a time entirely in a unified format. For this purpose, there is known a technique using a template in which processing to subdivide parameters to extract required data therefrom is produced by use of a template. According to the template, an interface of application program is created using screen information.

Although the parameters can be subdivided into data items, to relate the subdivided data items to application programs coded in various languages, know-how of respective languages is required. When the languages of the programs are amicable to the program to display screen images, this does not lead to any critical problem. However, in a case in which the languages are to be related to a program of a programming language such as COBOL having few functions to display screen images or not having such a screen display function, there arises a problem even when the interface is produced. That is, when the interface is used, efficiency of program developement and reusability of programs are deteriorated.

### SUMMARY OF THE INVENTION

It is therefore an object of the present invention, which has been devised to solve the problem of the prior art, to provide a program generation method, a program execution method, and an apparatus to achieve the methods in which for a program developer to easily relate an application program coded in a desired programming language to another program, a skeleton of an application program coded in the programming language is generated.

To achieve the object according to one aspect of the present invention, there is provided a program generation method in which a skeleton of an application program is automatically generated by creating a screen file.

To achieve the program generation method according to one aspect of the present invention, there is provided a method including a step of defining, in the screen file, data to be inputted, a step of defining a function name for the call, and a step to specify a language used for development.

According to one aspect of the present invention, there is provided a method including a step of extracting required data from parameters concatenated to each other and a step of converting data according to a data definition of each associated language.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an embodiment of a configuration of products according to the present invention.

FIG. 2 is a block diagram conceptually showing program generation according to the present invention.

FIG. 3 is a block diagram showing a display example of a screen file according to the present invention.

FIG. 4 is a diagram showing details of a screen file according to the present invention.

FIG. 5 is a diagram showing a table of definition information according to the present invention.

FIG. 6 is a flowchart showing a processing flow of a generation tool according to the present invention.

FIG. 7 is a diagram showing details of a dynamic data referring screen file according to the present invention.

FIG. 8 is a diagram showing details of a program call division according to the present invention.

FIG. 9 is a diagram showing details of an application program skeleton according to the present invention.

FIG. 10 is a block diagram conceptually showing a program call division according to the present invention.

FIG. 11 is a flowchart showing a flow of data conversion according to the present invention.

FIG. 12 is a block diagram showing data conversion according to the present invention.

FIG. 13 is a diagram conceptually showing a development environment editor according to the present invention.

### DESCRIPTION OF THE EMBODIMENTS

Referring now to the drawings, description will be given of an embodiment according to the present invention.

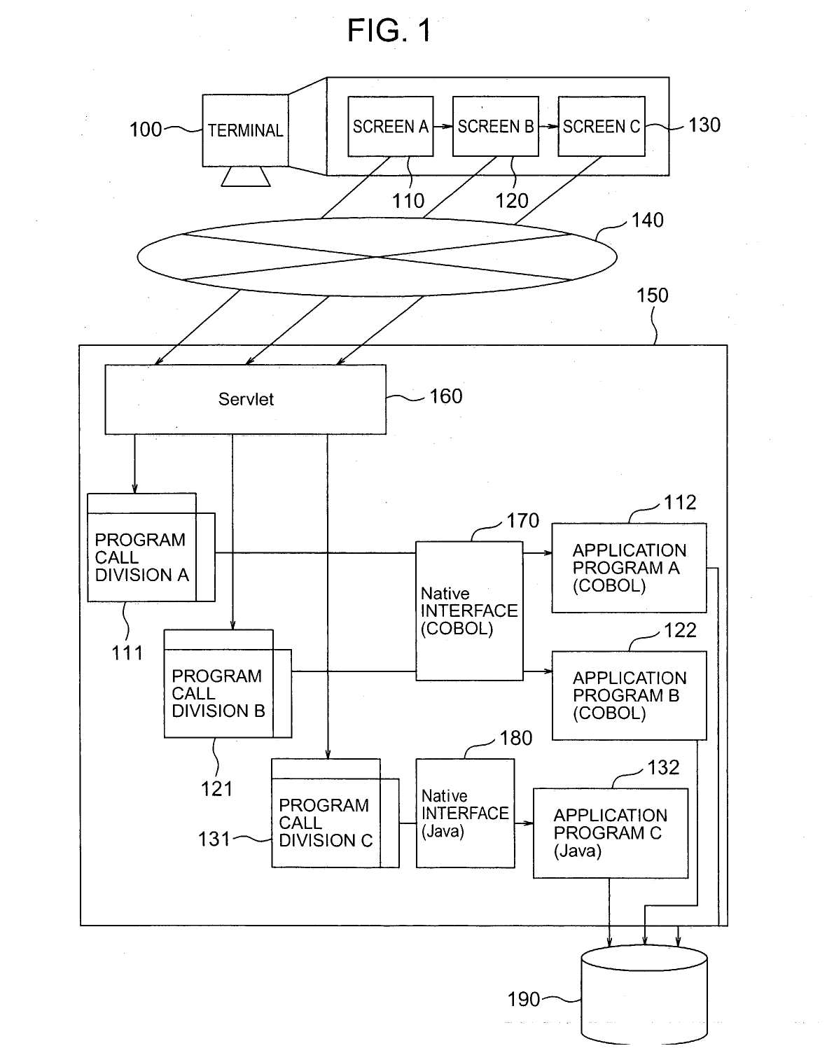

FIG. 1 shows an embodiment of processing of program call divisions and programs generated according to the present invention. On a terminal 100, the screen image thereof changes as screen A 110, screen B 120, and screen C 130. Each screen image or each screen requires data input and output operations, for example, for a user to input data or for an application program to refer to data. Each screen accesses a web server 150 via a network 140. Data is transmitted from the screen in the form of a request. The request includes input data items inputted by the user and various data items necessary for data transmission. These data items are concatenated or collectively related to each other. A servlet 160 has a function to transfer input data from the screen to a program call division associated therewith. Native interfaces 170 and 180 are interfaces respecitvely corresponding to COBOL and Java (a trademark or a registered trademark of Sun Microsystems, Inc.). Each interface conceals a required data conversion between various programming languages from developers.

The servlet 160 receives an access request or an access from screen A 110 and passes a request to program call division A 111 corresponding to screen A 110. Program call division A 111 extracts, from the request, data to be passed to COBOL application program A 112. The extracted data is converted into data of a data type specified as a parameter of COBOL application program A 112. Program call division A 111 sets the data of the data type via the Native interface (COBOL) 170 to COBOL application program A 112. Finally, the servlet 160 executes program A 112.

The servlet 160 receives an access from screen B 120 and passes a request to program call division B 121 corresponding to screen B 120. Program call division B 121 extracts, from the request, data to be passed to COBOL application program B 122. The extracted data is converted into data of a data type specified as a parameter of COBOL application program B 122. Program dall division B 121 sets the data via the Native interface (COBOL) 170 to COBOL application program B 122. Finally, the servlet 160 executes program B 122.

The servlet 160 receives an access from screen C 130 and passes a request to program call division C 131 corresponding to screen C 130. Program call division C 131 extracts, from the request, data to be passed to Java application program C 132. The extracted data is converted into data of a data type specified as a parameter of Java application program C 132. Program dall division c 131 sets the data via the Native interface (Java) 180 to Java application program C 132. Finally, the servlet 160 executes program C 132.

Each application program accesses a database 190 according to necessity.

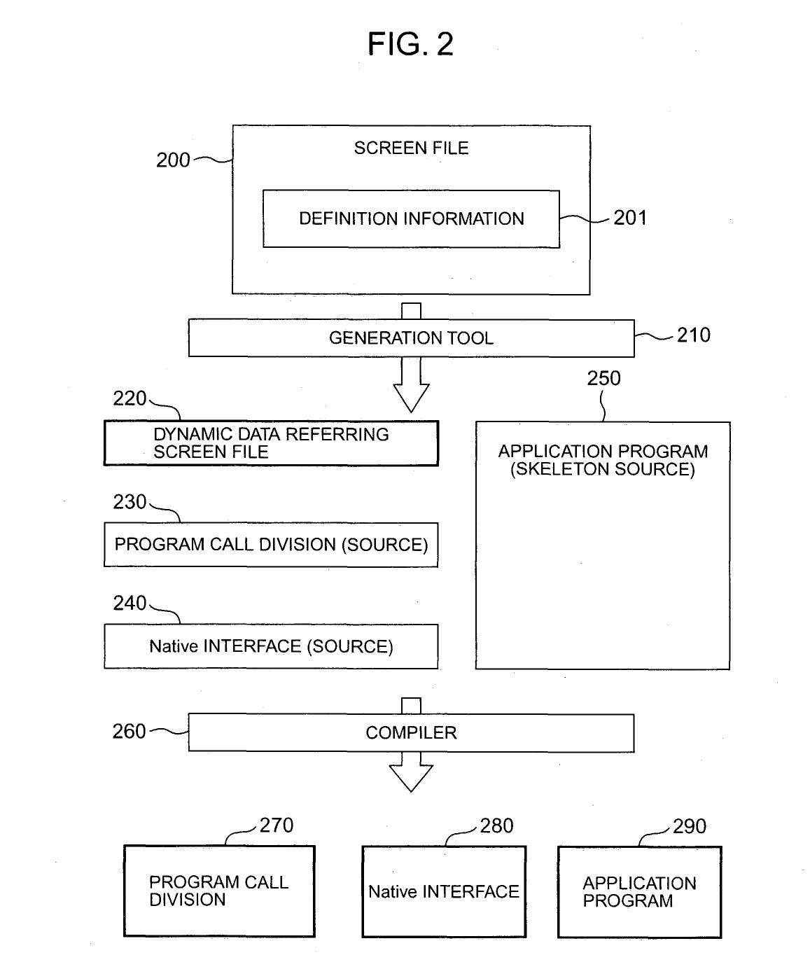

FIG. 2 shows a program generation procedure in a flowchart according to the present invention. To create an application program, data items such as a function name, a language, and a parameter of an application program and information items such as a name assigned to a call division to call an application program are defined in definition information 201 in a screen file 200. A generation tool 210 reads the definition information 201 to create a file necessary to call an application program from a screen. Description will now be given of products of the program generation procedure. A dynamic data referring screen file 220 has a function to input/output data dynamically, for example, a function to input data from a screen and a function to acquire data from an application program to display the data. A source file 230 of the program call division and a source file 240 of the Native interface serve as interfaces to communicate data between a screen and an application program. Each file has functions such as a function of data conversion and data justification or alignemnt and a function of parameter extraction. Since a defined function name and data definition information of a section related to a screen are beforehand set in an application program skeleton 250, it is only necessary for the program developer to code a program section to implement necessary processing.

Each of the files generated by the generation tool is compiled using a compiler 260 associated with a program language. As a result, a program call division 270, a Native interface 280, and an application program 290 are produced.

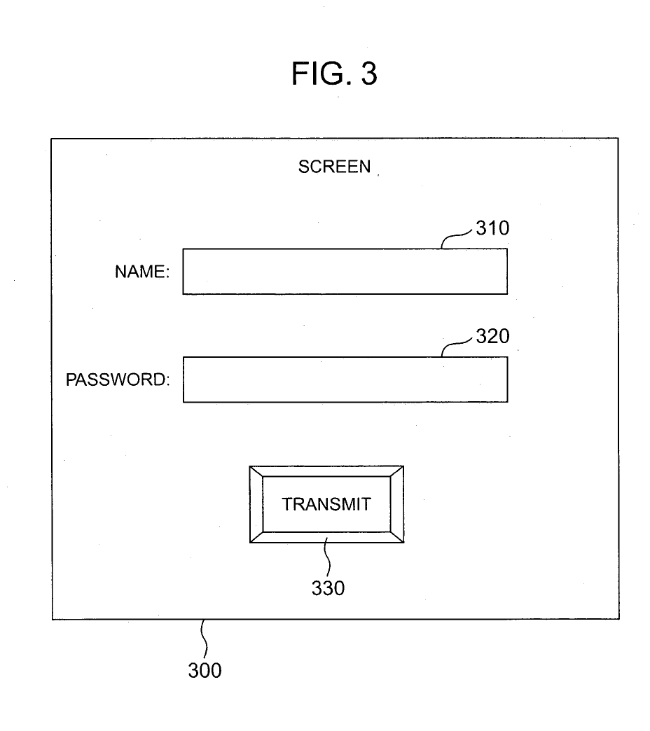

Referring to FIGS. 3 to 13 showing enbodiments, description will now be given of files and programs used in the generation procedure shown in FIG. 2.

FIG. 3 shows a display example of a screen file. A screen 300 includes a text field 310 to input a name, a text field 320 to input a password, and a transmit button 330 to transmit form data.

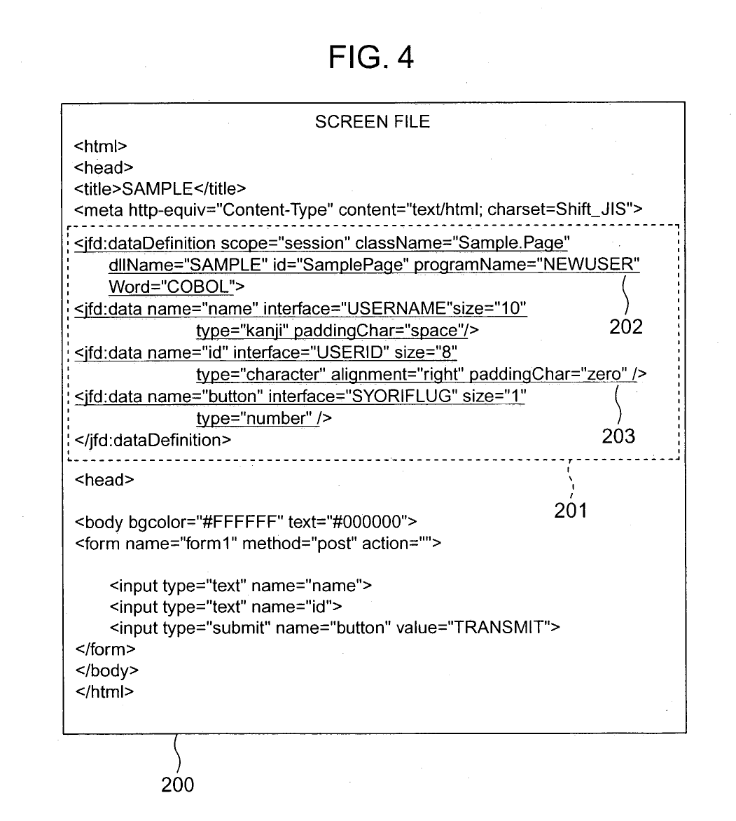

FIG. 4 shows a screen file 200 in detail. This example is described in a tag language to control display of a screen. Definition information 201 includes a unique extention tag “jfd” to define information unique to the present invention. An underscored section or description 202 defines function information. A name of a program call division is specified in a className attribute. A dynamic link library (DLL) file name of an application program to be called and an actual program name (function name) thereof are specified in dllName and programName attributes, respectively. A language is specified in a Word attribute. A range of a life cycle of a dynamic data referring screen file and an identifier to access a program call division are defined by scope and id attributes, respectively. An underscored section 203 defines data definition information. When a name specified by a name attribute is equal to one of the input/output objects in the screen file, the data is related to the object. An interface attribute is used to specify a name of data used in the application program. A size attribute specifies a data length. A type attribute specifies a data type. An alignment attribute specifies an aligning or justifying method. A paddingChar attribite is used to specify a character such as space, zero, or null for the padding operation.

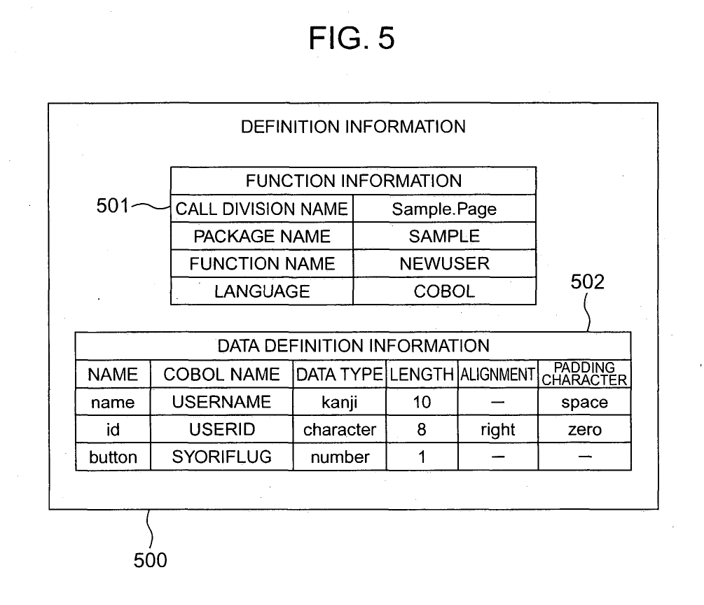

FIG. 5 shows, in a table, information items defined by the extension tags in a generation stage. Function information 501 of definition information 500 indicates that the name of the program call division corresponding to the screen is Sample.Page, the DLL name of the calling application program is SAMPLE, the program name is NEWUSER, the language used for development is COBOL. Data definition information 502 indicates that data defined by a name of “name” in the screen file 200 is mapped onto a variable “USERNAME” in the application program, the data type is “kanji type”, the data length is ten characters, and the padding character is “space”. Data defined by a name of “id” is mapped onto a variable “USERID” in the application program, the data type is “character type”, the data length is eight characters, and the padding character is “zero (0)”. Data defined by a name of “button” is mapped onto a variable “SYORIFLUG” in the application program, the data type is “number type”, the data length is one character, and the padding character is not used.

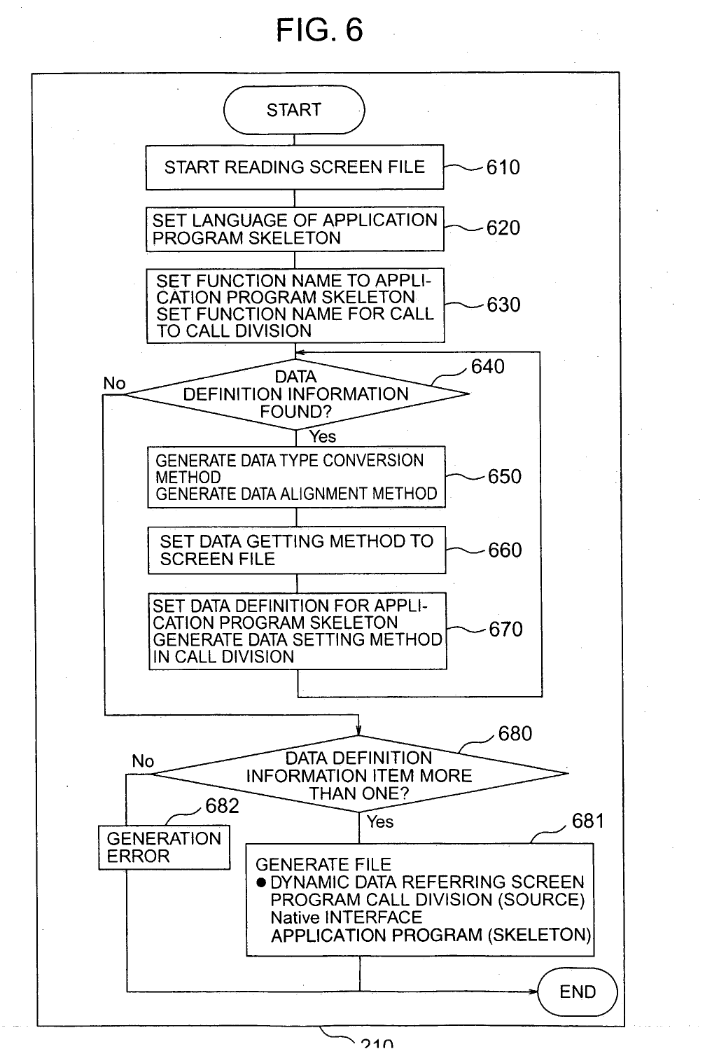

FIG. 6 shows a processing flow of the generation tool 210. The flow will be described by referring to FIGS. 4, 5, 7, 8, and 9. In step 610 to read the definition information 201 of the screen file 200 shown in FIG. 4, items specified by the extension tags jfd are extracted from the screen file 200 to create the definition information table 500 of FIG. 5 using the information of attribute values defined in the items. The table 500 includes a function information table 501 and a data definition information table 502.

The call division name of the table 501 is a name of a call division corresponding to the screen and is the attribute value of className in the underscored section 202 of FIG. 4. The package name indicates a dll file name when the application program is transformed into a dll file. The dll file name is the attribute value of dllName in the jfd tag. The function name is a name of an application program to be called and is the attribute value of “programName”. The language specifies a development language used to develop the application program and is the attribute value of “Word”.

The name of the data definition information table 502 is a name related to an actual form object in the screen file 200 and is the attribute value of “name” in the underscored section 203 of FIG. 4. “COBOL name” is a data definition name used in the application program. That is, a data name inputted from the screen is assigned as another name for the application program. The name is the attribute value of “interface” in the jfd:data tag. The data type indicates a type of data used in the application program and is the attribute value of “type”. The length indicates a data length and is the attribute value of “size”. The alignment indicates alignment or justification necessary for data (such as justification of data on the right or left) and is the attribute value of “alignment”. The padding character is a character to be padded in an unused section of data and is the attribute value of “paddingChar”.

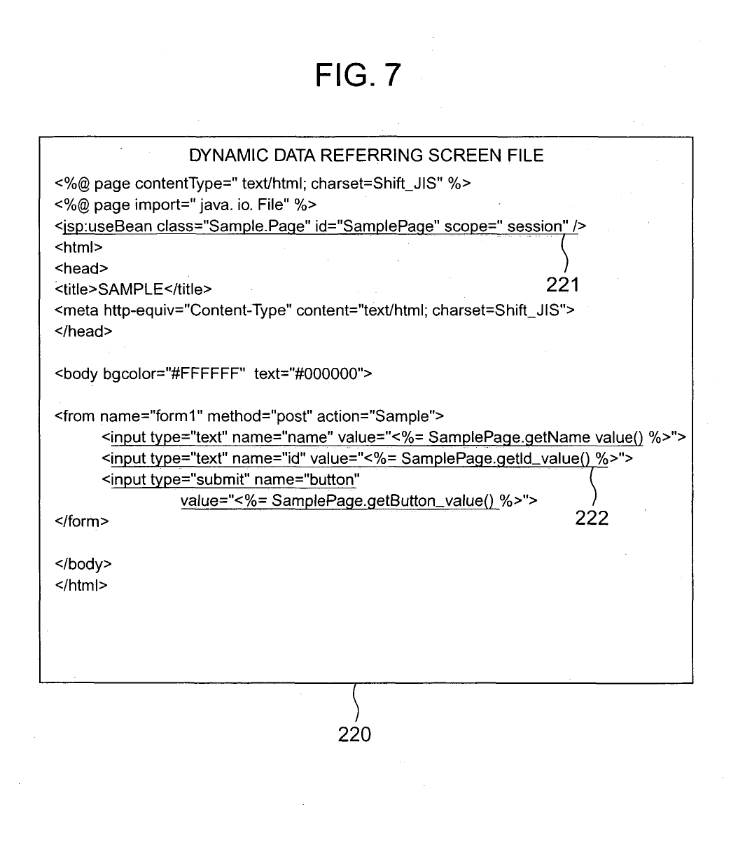

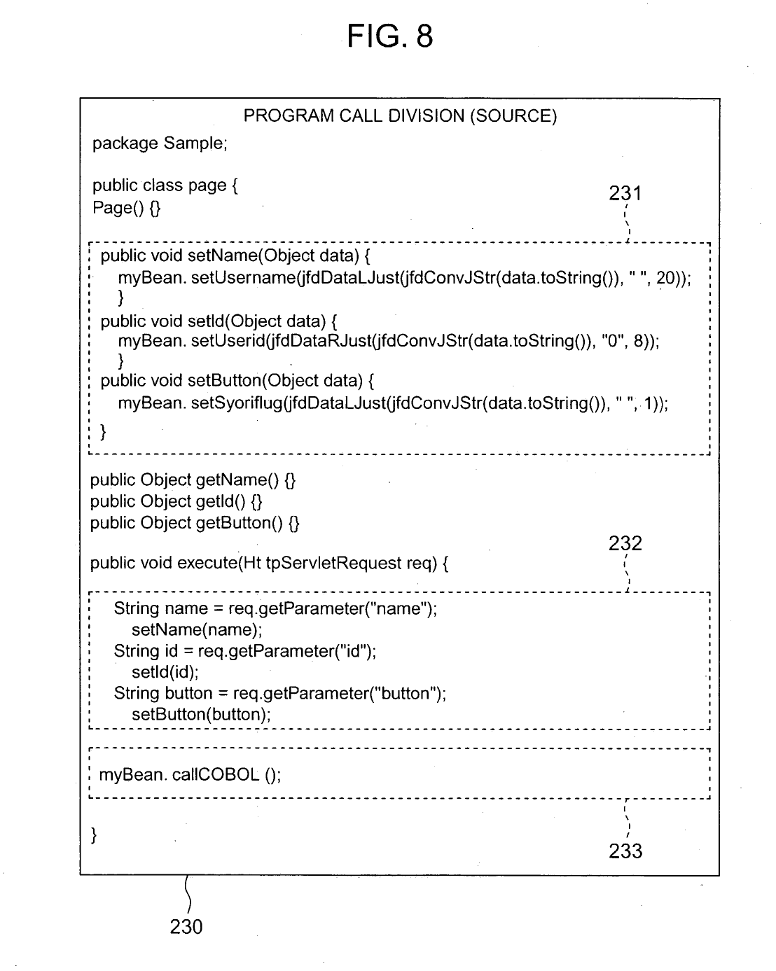

A language setting step 620 of the application program skeleton 250 is set according to an item of the language in the function information table 501. In step 630 to set a function name for the call to the application program skeleton 250 and the Native interface (source) 240, the system refers to the item of the function name in the function information table 401. “PROGRAM-ID.NEWUSER.” is set to the application program skeleton 250. In step 640 for a branch according to detection of data definition information, each record is read from the data definition information table 502 in a record-by-record fashion. If data is defined in advance, the system refers to the item of “data type” to generate a data type conversion method and then refers to the items of “length”, “alignment”, and “padding character” to generate a data alignment method in step 650. A jfdConvJStr method and a jfdLjust, jfdRjust method are generated in the data conversion division or section 231 of the program call division (source) 230 shown in FIG. 8. In step 660 to generate a data acquiring or collecting method, the name attribute of the object defined in the screen file 200 is collated with that of data defined by the jfd extension tag. If these items are equal to each other, the system executes processing to incorporate a method to obtain data from the program call division. A data acquiring method is added to each value attribute in the underscored section 222 of the dynamic data referring screen file 220 shown in FIG. 7.

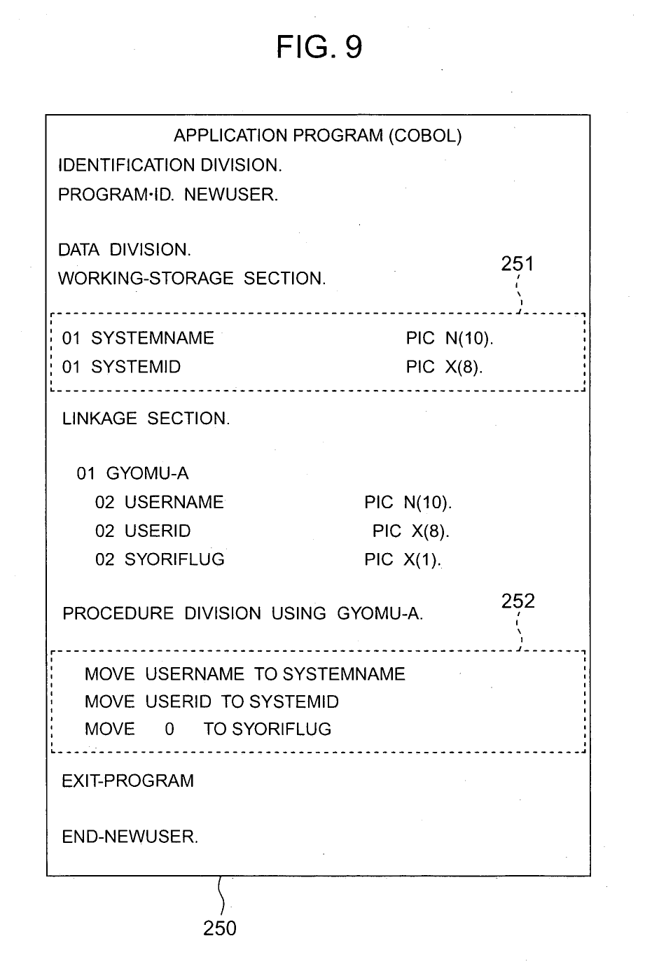

Next, the system executes processing of step 670 to set a data definition and a data setting method to the application program skeleton 250 and the program call division 230. Necessary items are generated in the data conversion division 231 and a data extraction division 232 of FIG. 8 according to the respective data definitions. In the application program skeleton 250 of FIG. 9, associated data definitions are generated as an item of a COPY clause in the linkage section. In step 680 for a branch according to end judgement, if no data definition is detected, step 682 of error processing is executed and the processing is terminated without generating any file. If one or more data definitios are present, step 681 is executed to generate each file.

FIG. 7 shows a detailed code of the dynamic data referring screen file 220. An underscored section 221 is a code or program to access the program call division. The attribute value of “class” is the attribute value of “className” in the underscored section 202 of the screen file 200. The attribute value of “id” is that of “id” in the underscored section 202. The attribute value of “scope” is that of “scope” in the underscored section 202. Information items defined by the jfd extension tags in the screen file 200 are entirely deleted. The underscored section 222 is a description section of the form object. This specifies a method as the value attribute, the method being used, when the data definition information in the underscored section 203 of the screen file 200 includes an attribute value of the same name, to obtain data of the name. As a result, it is possible to obtain data from the application program to display the data as an initial value.

FIG. 8 shows a detailed code of the program call division 230. In the data type conversion, alignment, and processing section 231, methods “setName”, “setId” and “setButton” to set data to the Native interface are defined in association with data inputted from the screen. In each method, a method of one of “setUsername”, “setUserid” and “setSyoriflug” is called to actually set data to the application program. The data specified as a parameter is passed to a method “jfdConvJStr” with data represented in a character string, a padding character (such as space or zero), and a numeric value representing the length of the character string. Then the method returns a character string of the specified length in which an unused part is filled with the padding character. When the data is passed to a method “jfdDataRjust” or “jfdDataLjust”, data of a character string in which the data is justified on the right or left is obtained. The data is then set to the application program.

A parameter extraction and setting section 232 uses a method “getParameter” to obtain parameters from the request, the parameters being set with names “name”, “id”, and “button”. The extracted data is set to the Native interface using a setting method defined in the data type conversion, alignment, and processing section 231.

After the data extraction and the data conversion and setting are finished, a program call division 233 executes an application program call processing using a method “callCOBOL”.

FIG. 9 shows a detailed code of the application program skeleton 250. The skeleton 250 includes a section in which a function name and data definitions for input/output operations with the screen are defined according to the definition information 201 of the screen file 200 and a data definition section 251 and an actual processing section 252 which are installed by the developer. In the development, the developer codes the actual processing section 252 in the file of the application program skeleton generated as above. The developer then compiles the source program and then allocates the compiled program in the system. “IDENTIFICATION DIVISION.”, “PROGRAM-ID.”, “DATA DIVISION.”, “WORKING-STORAGE SECTION.”, “LINKAGE SECTION.”, “PROCEDURE DIVISION USING GYOMU-A”, “EXIT-PROGRAM”, and “END-” are stored as templates to generate a program in COBOL and hence are automatically generated when the application program is generated. Using the extracted parameters, “01 GYOMU-A.”, “02 USERNAME PIC N(10).”, “02 USERID PIC X(8).”, AND “02 SYORIFLUG PIC X(1).” are generated. A structure name “GYOMU-A” can be automatically allocated by the system or can be set according to information inputted from an operator.

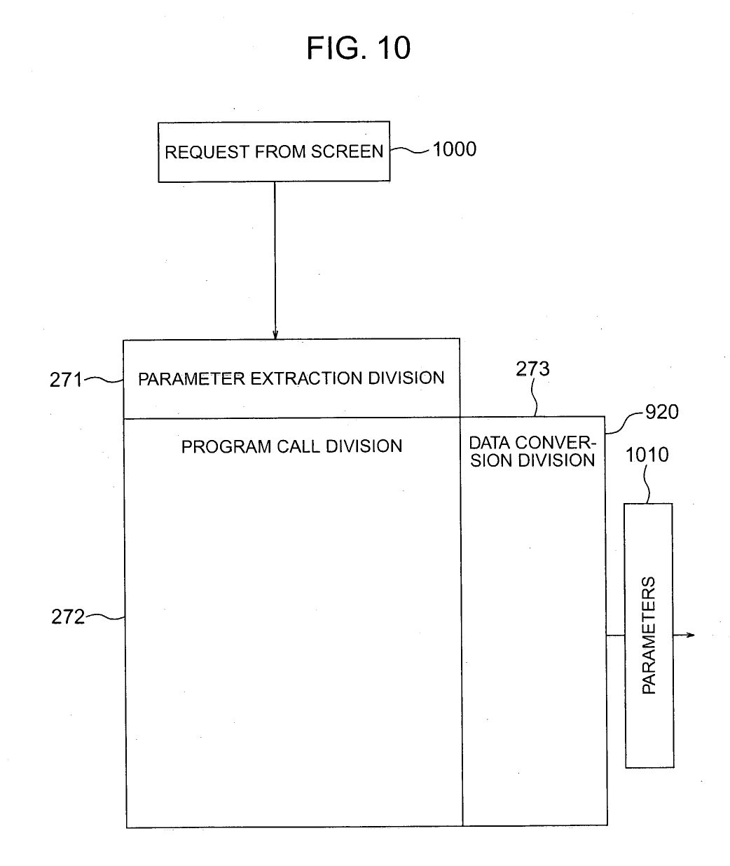

FIG. 10 shows details of the program call division 270 compiled as above. From the screen 300 shown in FIG. 3, a text field 310 for a name, a text field 320 for a password, and a button 330 are stored in a request with respective parameter names “name”, “id”, and “button” as shown in FIG. 7. The request 1000 is then sent to the program call division 270. The division 270 receives the request 1000 and the parameter extraction division 271 extracts data of the name parameter, data of the id parameter, and data of the button parameter. The data conversion division 273 to convert data into a type and a form for the application program maps the data “name” onto a variable “USERNAME” of the application program to convert the data into data of kanji type with a data length of ten characters using “space” as the padding character. The division 273 maps the data “id” onto a variable “USERID” of the application program to convert the data into data in the character type with a data length of eight characters using “0” as the padding character, the data being justified on the right. The division 273 maps the data “button” onto a variable “SYORIFLUG” to convert the data into data of number type with a data length of one character.

The program call division 272 converts the extracted data as shown in FIG. 8 and then passes parameters 1010 necessary for the application program to the Native interface. The division 272 sets all necessary parameters and then executes the application program.

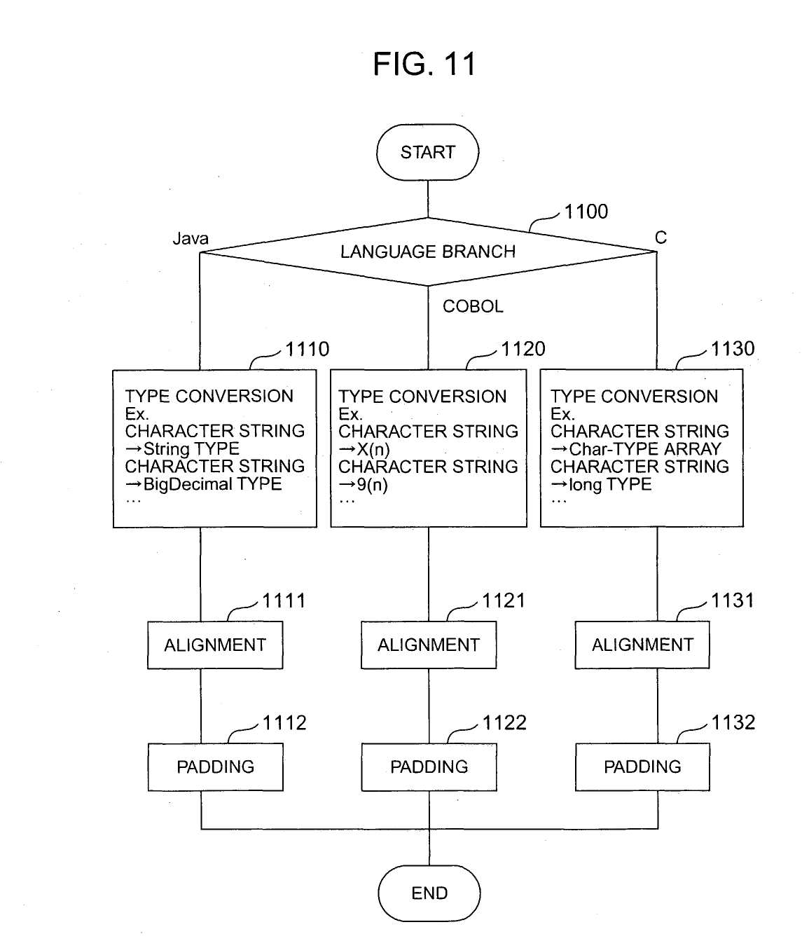

FIG. 11 shows a processing flow of the data conversion division. The processing flow includes a language branch step 1100, a Java conversion step 1110, a Java alignment step 1111, a Java padding character step 1112, a COBOL conversion step 1120, a COBOL alignment step 1121, a COBOL padding character step 1122, a C language conversion step 1130, a C language alignment step 1131, and a C language padding character step 1132.

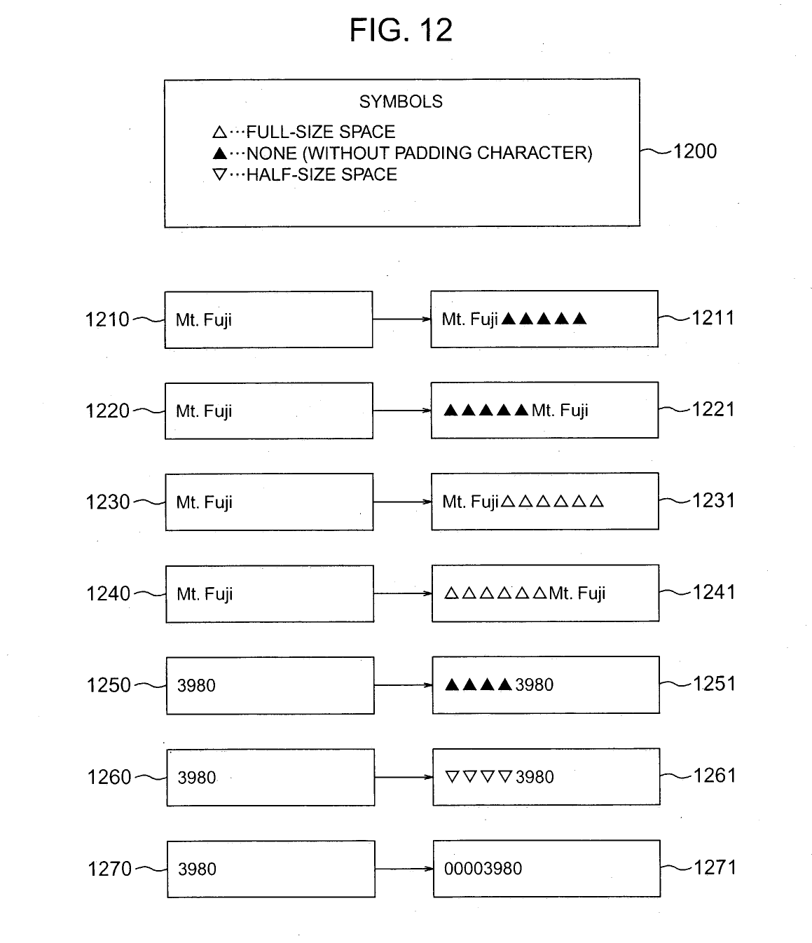

FIG. 12 shows data alignment and a padding character. Description will be given of the operation using symbols 1200 shown in an upper section of FIG. 12. When the data alignment or justification and the padding character are not specified, input data 1210 is mapped as indicated by numeral 1211. When the right justification is conducted for input data 1220, the data is stored as indicated by numeral 1221. When the left justification is conducted for input data 1230 using “space” as a padding character, the data is stored as indicated by numeral 1231. When the right justification is conducted for input data 1240 using “space” as a padding character, the data is stored as indicated by numeral 1241. When the data justification and the padding character are not specified for a numeric value of data 1250, the data is stored as indicated by numeral 1251. When the right justification is conducted for a numeric value of data 1260 using “half-size space” as a padding character, the data is stored as indicated by numeral 1261. When the right justification is conducted for a numeric value of data 1270 using “0” as a padding character, the data is stored as indicated by numeral 1271.

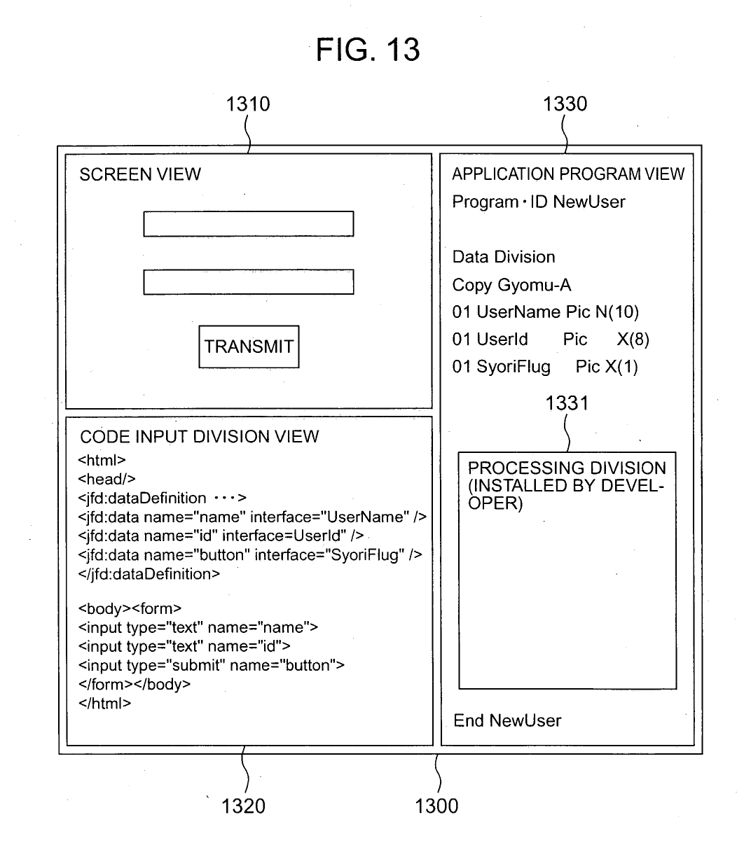

FIG. 13 conceptually shows a development environment editor 1300 according to the present invention. While watching a screen view 1310 actually displaying a screen image, the developer edits a screen file using a code view 1320. An application program view 1330 displays the application program skeleton generated using definition information of the screen file. By visually checking the view 1330, the developer edits a processing division 1331 to be installed by the developer to thereby generate an application program.

Description will now be given of a general flow of products of the processing.

On the screen 300 displayed by the processing of the dynamic data referring screen file 220, when the developer inputs a name in the text field 310 and a password in the text field 320 and then depresses the transmit button 330, the name, the password, and information of depression of the transmit button are set as parameters “name”, “id”, and “button”, respectively. The parameters are linked with other data items necessary for transmission to form a request 1000. The request is sent via the network 140 to the servlet 160 on the web server 150. Having received the request 1000, the servlet 160 directly transfers the request 1000 to a program call division corresponding to the screen.

The program call division 272 receives the request 1000 by the parameter extraction division 271 and extracts the parameters “name”, “id”, and “button” using a getParameter method. The data conversion division 273 converts data items of these parameters. Data “name” is converted into ten-character data of kanji type using “space” as a padding character. Data “id” is converted into eight-character data of character type using “0” as a padding character, the data being right justified. Data “button” is converted into one-character data of number type. The parameters “name”, “id”, and “button” are respectively related to USERNAME, USERID, AND SYORIFLUG in the application program. The parameters are therefore set using a setting method of the Native interface (COBOL) 170. Immediately after the setting of the parameters, the program call division 272 executes the COBOL application program. After the developer installation sections 251 and 252 to be installed by the developer in the application program skeleton 250 of FIG. 9 are coded and complied, the application program 290 is executed. Since the Native interface 280 beforehand sets the parameters to be referred from the application program 290, the application program 290 refers to the parametes to execute processing using USERNAME, USERID, and SYORIFLUG.

According to the present invention, it is possible to easily relate application programs coded in various programming languages to each other.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A program generation method, comprising the steps of:
inputting a screen file described in a language to display a screen or to control display of a screen; and
generating, according to the screen file, a skeleton of an application program to conduct a predetermined job using parameters of which data items are obtained from the screen file, the parameters being used as input data.

2. A program generation method according to claim 1, further comprising the steps of:
defining, when editing the screen file, a type or an attribute of data obtained in a form of the screen;
specifying a function name to call the application program; and
specifying a programming language used to code the application program.

3. A program execution method for executing a program generated by the method of claim 2, comprising the steps of:
extracting, when calling the application program, data from a data group of a predetermined format, the data being required to call the application program; and
converting the data according to a data definition of the programming language used to code the application program.

4. A program generation apparatus, comprising:
means for inputting a screen file described in a language to display a screen or to control display of a screen; and
means for generating, according to the screen file, a skeleton of an application program to conduct a predetermined job using parameters of which data items are obtained from the screen file, the parameters being used as input data.

5. A program generation apparatus according to claim 4, further comprising:
means for defining, when editing the screen file, a type or an attribute of data obtained in a form of the screen;
means for specifying a function name to call the application program; and
means for specifying a programming language used to code the application program.

6. A program execution apparatus for executing the program generated by the apparatus of claim 5, further comprising:
means for extracting, when calling the application program, data from a data group of a predetermined format, the data being required to call the application program; and
means for converting the data according to a data definition of the programming language used to code the application program.

7. A program generation program, comprising the codes for executing the steps of:
inputting a screen file described in a language to display a screen or to control display of a screen; and
generating, according to the screen file, a skeleton of an application program to conduct a predetermined job using parameters of which data items are obtained from the screen file, the parameters being used as input data.

8. A program generation program according to claim 7, further comprising the codes for executing the steps of:
defining, when editing the screen file, a type or an attribute of data obtained in a form of the screen;
specifying a function name to call the application program; and
specifying a programming language used to code the application program.

9. A program execution program for executing a program generated by the program of claim 8, comprising the codes for executing the steps of:
extracting, when calling the application program, data from a data group of a predetermined format, the data being required to call the application program; and
converting the data according to a data definition of the programming language used to code the application program.
